(19) United States
(12) Patent Application Publication
(10) Pub. No.: US 2015/0041179 A1
(43) Pub. Date: Feb. 12, 2015

(54) POLE PART FOR MEDIUM VOLTAGE USE, AND METHOD FOR MANUFACTURING THE SAME

(71) Applicant: ABB Technology AG, Zurich (CH)

(72) Inventors: Arne KLASKA, Dusseldorf (DE); Dietmar GENTSCH, Ratingen (DE); Robin ENGELKE, Winsen (DE); Wilfried BAIER, Ratingen (DE)

(73) Assignee: ABB Technology AG, Zurich (CH)

(21) Appl. No.: 14/522,052

(22) Filed: Oct. 23, 2014

Related U.S. Application Data
(63) Continuation of application No. PCT/EP2013/001211, filed on Apr. 23, 2013.

(30) Foreign Application Priority Data
Apr. 23, 2012 (EP) 12002834.5

(51) Int. Cl. H01B 17/14; H01B 7/282; H01B 7/02

(52) U.S. Cl. CPC H01B 17/145; H01B 7/02; H01B 7/2825
USPC 174/158 F

(57) ABSTRACT

A pole part for medium voltage use, with an insulating coverage made of duroplastic or thermoplastic material, and a method for manufacturing the pole part are provided. To enhance the manufacturing of pole parts, such that the manufactured pole part could be more easily released out of the mold, and additionally that the interface between elements made of different materials are tightly closed, in order to generate reproducible dielectric withstand performance in the manufacture, the transition area between different elements of the pole part are commonly flat in such a way that rounded edges and/or steps are avoided.

### RELATED APPLICATIONS

This application claims priority as a continuation application under 35 U.S.C. §120 to PCT/EP2013/001211, which was filed as an International Application on Apr, 23, 2013 designating the U.S., and which claims priority to European Application 12002834.5 filed in Europe on May 20, 2013. The entire contents of these applications are hereby incorporated by reference in their entireties.

### FIELD

The present disclosure relates to a pole part for medium voltage use, with an insulating coverage made of duroplastic or thermoplastic material, and to a method for manufacturing such a pole part.

### BACKGROUND INFORMATION

Insulating coverages for pole parts are using molding technology.

For the use of duroplastic coverage, which is manufactured, for example, as an epoxy resin, as well as for the use of thermoplastic coverage, which is manufactured by injection molding, for example, sealings are used between inlays (e.g. contact terminals) and mold in order to avoid over-spraying or leakage of the mold, especially during the injection molding process.

Separate sealing elements like O-rings, for example, are used for low pressure injection during the molding process, for example.

In case separate sealing elements are not used, line contact (1-dimensional) sealing by metallic sealing, high pressure injection, is used, such as on rounded, circular edges on the contact terminal and sharp, circular edge at the mold.

However, a drawback with known techniques is that in high pressure injection, for example, the mold cuts into the inlay which may be a contact terminal of the pole part. As a result, the release of the pole part from the mold after the molding process could be problematic due to the wedge function of the cutting of the sealing edge into the rounding of the inlay.

Another drawback is that the sealing function depends on the quality of rounding and requires quite narrow tolerances of the terminal in the sealing area, especially of rounding, which is difficult to measure and may give rise to quality issues.

The positioning of the inlays depends on the contact between the mold/additive part and the inlay, for example, the contact terminal of a medium voltage pole part. Because of this, the parallel alignment of specific surfaces is difficult.

### SUMMARY

An exemplary embodiment of the present disclosure provides a pole part for medium voltage use. The exemplary pole part includes an insulating coverage made of duroplastic or thermoplastic material. Transitions between different materials and topographic structures of at least one of a vacuum interrupter and connecting terminals are covered tightly by the insulating coverage commonly molded thereto. A transition area between different elements of the pole part are commonly flat in such a way that at least one of rounded edges and steps are avoided.

An exemplary embodiment of the present disclosure provides a method for manufacturing a pole part for medium voltage use. The pole part has an insulating coverage made of duroplastic or thermoplastic material. The exemplary method includes covering tightly transitions between at least one of different materials and topographic structures of at least one of a vacuum interrupter and connecting terminals by the insulating coverage commonly molded thereto. The exemplary method also includes arranging a transition area between different elements of the pole part to be commonly flat or laying in a common plane area. Before molding, the exemplary method includes positioning sealings in the commonly flat or common plane area of the arranged transition area so that at least one of rounded edges and steps are avoided.

An exemplary embodiment of the present disclosure provides that the transition area between an inlay of the pole part and the mold are commonly flat in such a way that at least one of rounded edges and steps are avoided

### BRIEF DESCRIPTION OF THE DRAWINGS

Additional refinements, advantages and features of the present disclosure are described in more detail below with reference to exemplary embodiments illustrated in the drawings, in which:

FIG. 1 shows an exemplary embodiment of the present disclosure.

FIG. 2 shows a known configuration.

FIG. 3 shows features of the embodiment of FIG. 1 in more detail according to an exemplary embodiment of the present disclosure.

### DETAILED DESCRIPTION

Exemplary embodiments of the present disclosure provide a pole part for medium voltage use, with an insulating coverage made of duroplastic or thermoplastic material. According to an exemplary embodiment, transitions between different materials and/or topographic structures of an implemented vacuum interrupter and/or connecting terminals are covered tightly by the commonly molded insulating coverage. The transition area between different elements of the pole part are commonly flat in such a way that rounded edges and/or steps are avoided.

The placement of sealings in the mold for the resin or an injection process will become much more effective, because no steps or edges or rounded areas occur in the area on which the sealing comes into contact with the molded pole part. Therefore, each form of leakage which produces edges or ridges are avoided, so that the molded pole part can more easily be released out of the mold.

An advantage of the present disclosure is the simplification of manufacture and consequently cost reduction, as well as generating a safer production due to planar sealing and the avoidance of the aforementioned cutting edges.

According to an exemplary embodiment, in the aforementioned defined flat transition area, negative or positive topographic structures are implemented into the mold and/or into the contact part as a groove or a topographic ring, such that the topographic structure creates under mechanical impact force during mounting the parts into the mold a complementary structure in the opposite part. Due to this configuration, both corresponding topographies create a tight sealing effect during the molding process.

Furthermore, additional construction of sealing areas and alignment surface at contact terminals for thermoplastic pole parts in medium voltage applications are possible, which supports a high variety of pole part design.

According to an exemplary embodiment, the transition areas are located between the contact terminal of the pole part and the ending edge of the insulating coverage of the pole part.

According to an exemplary embodiment, the transition area between an inlay of the pole part and the mold are commonly flat in such a way that rounded edges and/or steps are avoided.

An exemplary embodiment of the present disclosure provides a method for manufacturing a pole part for medium voltage use, with an insulating coverage made of duroplastic or thermoplastic material. Transitions between different materials and topographic structures of an implemented vacuum interrupter and/or connecting terminals are covered tightly by the commonly molded insulating coverage. According to an exemplary embodiment of the present disclosure, the transition area between different elements of the pole part are commonly flat or laying in a common plane or plane area in such a way that before molding (e.g. injection of the duroplastic or thermoplastic material), one or more sealings are placed and positioned in a commonly flat area, so that rounded edges and/or steps are avoided, in order to avoid the occurrence of cutting edges in that area.

An exemplary embodiment of the method according to the present disclosure provides that the transition areas and the sealings are located between the contact terminal of the pole part and the ending edge of the insulating coverage of the pole part in such a way that no cutting edge occurs.

An exemplary embodiment of the method according to the present disclosure provides that the transition area between an inlay of the pole part and the mold are commonly flat in such a way that rounded edges and/or steps are avoided.

FIG. 1 shows an exemplary embodiment according to the present disclosure, in which the sealing area 10 is between a plastic part 1 and a contact part 2 of an electric terminal of a pole part. The area in which the sealing during the molding will be located is flat. This means that between the material transition from the plastic part 1 and the contact terminal part 2, there is not any step or grave; it is flat, so that no cutting edge will occur during the molding. Position number 5 shows a part of the mold. The contact part 2 here, is an inlay.

FIG. 3 illustrates features of FIG. 1 in more detail, in accordance with an exemplary embodiment of the present disclosure. In FIG. 3, in the flat area 10, there is a localized topographic structure 21 into the mold made of steel, for example, which cuts into the contact part 2 when the contact part 2 is introduced into the mold 5.

This will produce a groove 20 in the aluminium contact part 2, for example, in the area of the sealing area 10, so that the topographic ring 21 of the mold 5 corresponds tightly as a sealing with the groove 20 in the contact part 2.

The flat area 10 can also be arranged so that multiple grooves 20 can be formed in parallel, and corresponding parallel topographies 21 can be formed in the mold.

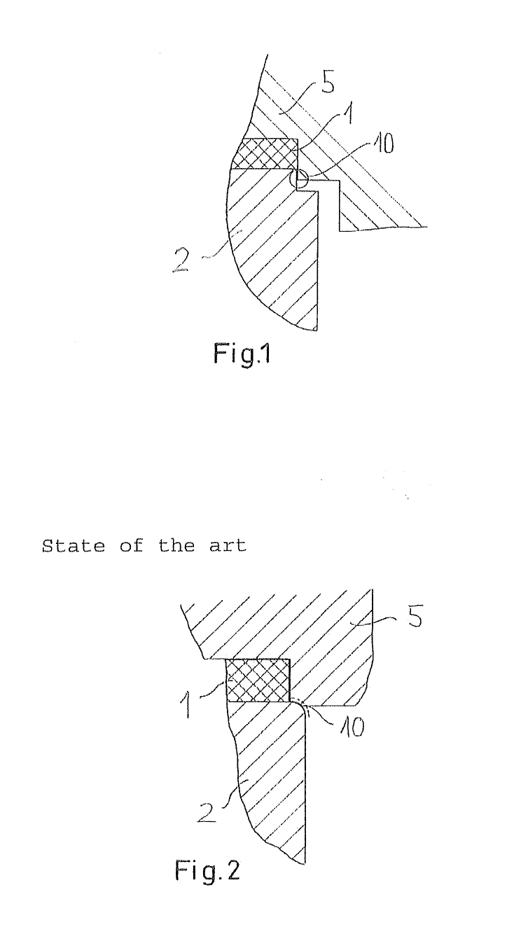

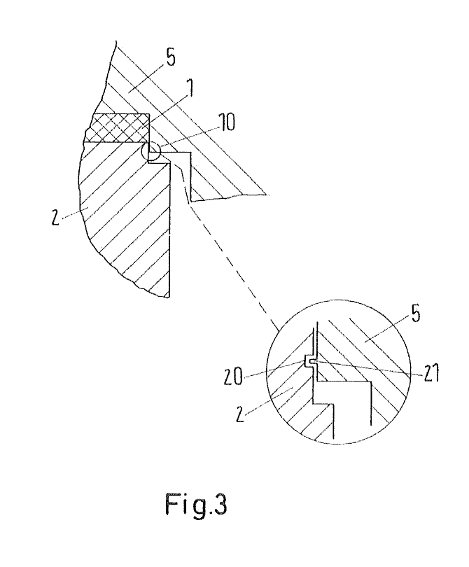

FIG. 2 shows a known configuration in contrast to the present disclosure. It is seen that the transition area between the plastic part and the contact part causes a prominent edge, so that a sealing in that area cannot be optimal. As a result, a cutting edge will occur during the molding, so that the ready pole part cannot easily be put out of the mold.

The present disclosure provides a number of advantages.

An additional sealing area (integrated sealing area) is easily given by the constructive solution.

A planar sealing, th.m. a 2-dimensional sealing area is created without any third dimension steps.

The resulting advantageous sealing for injection molding is given for thermoplastic and similar materials.

Also, a metallic sealing without additional sealing elements is possible, if the sealing area is created according to the present disclosure.

A secure sealing for high pressure injection is possible.

The sealing function is independent from outlines of inlay. That results in a complex possible outline.

An easy alignment of the inlay regarding position in the mold is given, since it just depends on easily to check dimensions and position tolerance of the sealing area.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practising the claimed disclosure, from a study of the drawings, the present disclosure, and the appended claims. In the claims, the word “comprising” or “including” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

It will therefore be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A pole part for medium voltage use, comprising:
an insulating coverage made of duroplastic or thermoplastic material, wherein transitions between different materials and topographic structures of at least one of a vacuum interrupter and connecting terminals are covered tightly by the insulating coverage commonly molded thereto,
wherein a transition area between different elements of the pole part are commonly flat in such a way that at least one of rounded edges and steps are avoided.

2. The pole part according to claim 1, wherein the transition area between an inlay of the pole part and the mold are commonly flat in such a way that at least one of rounded edges and steps are avoided.

3. The pole part according to claim 1, wherein in the flat transition area, negative or positive topographic structures are implemented into at least one of the mold a contact part of the pole part as one of a groove and a topographic ring, such that the topographic structure creates, under mechanical impact, a force during mounting of the parts into the mold a complementary structure in the opposite part, so that both corresponding topographies are creating a tight sealing effect during a molding process.

4. The pole part according to claim 1, wherein the transition area is located between the contact terminal of the pole part and an ending edge of the insulating coverage of the pole part.

5. A method for manufacturing a pole part for medium voltage use, the pole part having an insulating coverage made of duroplastic or thermoplastic material, the method comprising:
covering tightly transitions between at least one of different materials and topographic structures of at least one of a vacuum interrupter and connecting terminals by the insulating coverage commonly molded thereto,
arranging a transition area between different elements of the pole part to be commonly flat or laying in a common plane area; and
before molding, positioning sealings in the commonly flat or common plane area of the arranged transition area so that at least one of rounded edges and steps are avoided.

6. The method according to claim 5, wherein the transition area is arranged before injection of the duroplastic or thermoplastic material.

7. The method according to claim 5, wherein the avoidance of at least one of rounded edges and steps prevents occurrence of cutting edges in the commonly flat or common plane area of the arranged transition area.

8. The method according to claim 5, comprising:
arranging a transition area between inlays of the pole part and the mold to be at least one of commonly flat and laying in a common plane area such that before molding, the sealings are positioned in a commonly flat area, so that at least one of rounded edges and steps are avoided.

9. The method according to claim 8, wherein the avoidance of at least one of rounded edges and steps prevents occurrence of cutting edges in the commonly flat or common plane area of the arranged transition area.

10. The method according to claim 8, comprising:
arranging a transition area between inlays of the pole part and the mold to be at least one of commonly flat and laying in a common plane area such that before molding, the sealings are positioned in a commonly flat area, so that at least one of rounded edges and steps are avoided.

11. The method according to claim 5, wherein the transition area and sealings are located between a contact terminal of the pole part and an ending edge of the insulating coverage of the pole part to prevent occurrence of cutting edges in the transition area.
